(19) United States
(12) Patent Application Publication
(10) Pub. No.: US 2003/0128271 A1
(43) Pub. Date: Jul. 10, 2003

(54) Spatial matching of raster output scanner bow to LED-bar image data

(76) Inventor: Steven J. Harrington, Webster, NY (US)

Correspondence Address: Geza C. Ziegler, Jr., Perman & Green, 425 Post Road, Fairfield, CT, 06430, US

(21) Appl. No.: 10/044,669

(22) Filed: Jan. 9, 2002

(51) Int. Cl. B41J 2/45

(52) U.S. Cl. 347/238

(57) ABSTRACT

A multiple image station printer system comprising a first imaging station and a second imaging station. The first imaging station can comprise a laser raster output scanner imager. The second station is adapted to be adjusted in order to output an image that matches an image bow that is present in an image produced by the first imaging station.

### BACKGROUND OF THE INVENTION

1. Field of the Invention

The disclosed embodiments relate to color printing system and, more particularly, to a highlight color printer including an LED bar imager and a raster output scanner imager.

2. Brief Description of Related Developments

A Raster Output Scanner (ROS) or a Light Emitting Diode (LED) print bar, also known as imagers and used in xerographic printers, are well known in the art. The ROS or the LED print bar is positioned in an optical scan system to write an image on the surface of a moving photoreceptor belt.

In a ROS system, a modulated beam is directed onto the facets of a rotating polygon mirror which then sweeps the reflected beam across the photoreceptor surface. Each sweep exposes a raster line to a linear segment of a video signal image. However, the use of a rotating polygon mirror presents several inherent problems. Bow and wobble of the beam scanning across the photoreceptor surface can result from imperfections in the mirror, slight misangling of the mirror or from the instability of the rotation of the polygon mirror. These problems typically require complex, precise and expensive optical elements between the light source and the rotating polygon mirror and between the rotating polygon mirror and the photoreceptor surface to correct for any imperfections. Additionally, optically complex elements are also needed to compensate for refractive index dispersion that causes changes in the focal length of the imaging optics of the ROS.

In a laser ROS imager there is typically some bow or distortion along the process direction. In a single imager, the bow or distortion is not generally noticed because the distortion is usually small and all of the scan lines in the image have the same distortion. However, when a second imager such as an LED bar is added to a black & white printer having an ROS imager, the distortion can become apparent because the LED imager does not generally generate images with bow. An LED print bar generally consists of a linear array of light emitting diodes. Each LED in the linear array is used to expose a corresponding area on a moving photoreceptor in response to the video data information applied to the drive circuits of the print bars. The photoreceptor is advanced in the process direction to provide a desired image by the formation of sequential scan lines.

### SUMMARY OF THE DISCLOSED EMBODIMENT(S)

Features of the disclosed embodiments are directed to a multiple image station printer system. In one embodiment the system comprises a first imaging station comprised of a laser raster output scanner imager and a second imaging station. The second station is adapted to be adjusted in order to output an image that matches an image bow that is present in an image produced by the first imaging station.

In another aspect, features of the disclosed embodiments are directed to a method of compensating for image distortion in a print system including a raster output scanner imager and a LED array bar imager. In one embodiment the method comprises determining an image bow of a scanline produced by the raster output scanner imager and adjusting a bow scan line compensation device in the LED array bar imager in order to match the image bow of the raster output scanner imager.

In a further aspect, the disclosed embodiments are directed towards a method of shifting pixel position of an LED array bar imager in a highlight color printer to match image distortion in an image formed by a raster output image. In one embodiment, the method comprises determining a bow of a first straight scan line produced by the raster output imager, and matching the bow of the first straight scan line to a second straight scan line of the LED array bar imager by adjusting a timing for an illumination of each pixel in the LED array bar in order to shift the pixel position in the process direction.

In yet another aspect, the disclosed embodiments are directed to a computer program product. In one embodiment the computer program produced comprises a computer useable medium having computer readable code means embodied therein for causing a computer to compensate for image distortion in a multiple image station printer system including a raster output scanner and a LED array bar imager. The computer readable code means in the computer program product also comprises computer readable program code means for causing a computer to determine an image bow of a scanline produced by the raster output scanner imager, and computer readable program code means for causing a computer to adjust a bow scan line compensation device in the LED array bar imager in order to match the image bow of the raster output scanner imager.

### BRIEF DESCRIPTION OF THE DRAWINGS

The foregoing aspects and other features of the present invention are explained in the following description, taken in connection with the accompanying drawings, wherein:

FIG. 1 is a schematic diagram of one embodiment of a system incorporating features of the disclosed embodiments.

FIG. 2 is a perspective view of one embodiment of a raster output scanner incorporating features of the disclosed embodiments.

FIGS. 3 and 4 are perspective views of embodiments of systems to mechanically adjust LED imager bow in system incorporating features of the disclosed embodiments.

FIGS. 5A-5C are illustrations of the effect of superimposing both ROS and LED scans.

FIG. 6 is a flowchart of one embodiment of a method incorporating features of the disclosed embodiments.

FIG. 7 is a schematic of one embodiment of a control circuit for adjusting bow of an LED imager in a system incorporating features of the disclosed embodiments.

FIG. 8 is a block diagram of one embodiment of an apparatus that can be used to practice the disclosed embodiments.

### DETAILED DESCRIPTION OF THE PREFERRED EMBODIMENT(S)

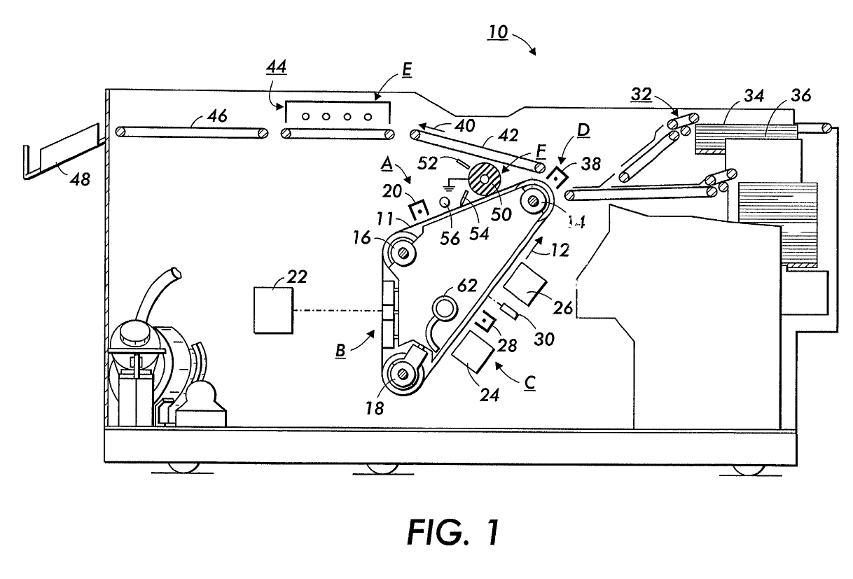

Referring to FIG. 1, there is shown an exploded perspective view of a system 10 incorporating features of the disclosed embodiments. Although the present invention will be described with reference to the embodiments shown in the drawings, it should be understood that the present invention can be embodied in many alternate forms of embodiments. In addition, any suitable size, shape or type of elements or materials could be used.

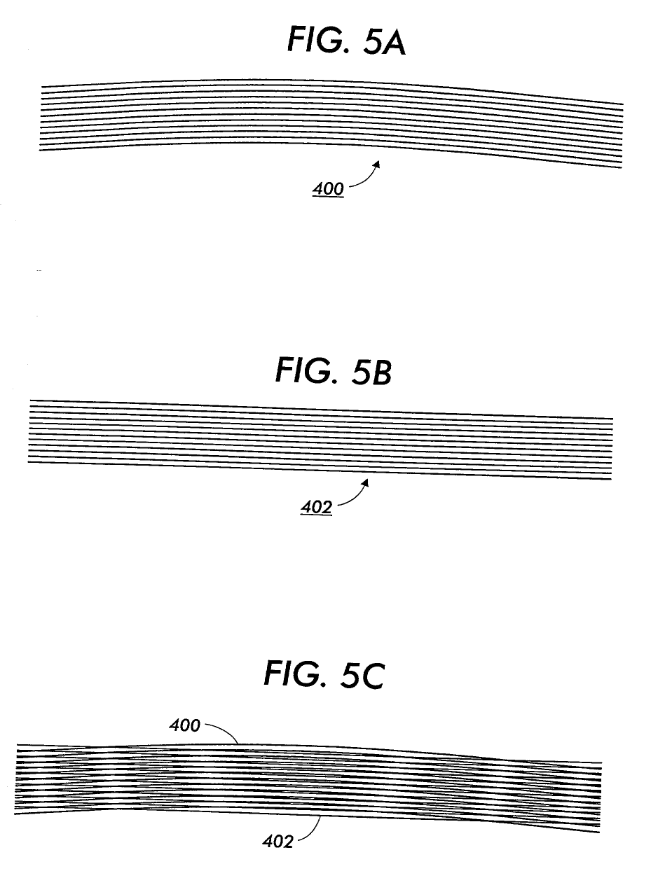

As shown in FIG. 1, the system 10 generally comprises a xerographic printer system. In alternate embodiments the system 10 could comprise any suitable printing or copying system. The system 10 incorporating features of the disclosed embodiments generally comprises a color printer that includes two imagers 24, 26, a raster output scanner imager 22 and a LED bar imager 30. In one embodiment, the system 10 can comprise a highlight color printer. The system 10 can also comprise a black and white printer have a laser raster output scanner imager 22 and an LED array bar imager 30 to provide the highlight color. Adding an LED bar imager for the highlight color to a black/white printer that has a laser ROS imager raises concerns about registration and alignment between the black and white and the highlight image. Referring to FIGS. 5A-5C, an example of image bow resulting in a image 403 from a ROS scan lines 400 superimposed on LED scan lines 402. Methods of the disclosed embodiments for eliminating the ROS bow include mechanically warping the optical elements to compensate or distorting the image data (electronic registration). It is a feature of the disclosed embodiments to be able to adapt, warp or adjust the LED array bar imager 30 to match the image bow that occurs in the raster output scanner imager.

Referring to FIG. 1, in one embodiment, the system 10 employs a belt 11 having a photoconductive surface deposited on a conductive substrate. Preferably, the photoconductive surface is made from a selenium alloy with the conductive substrate being made from an electrically grounded aluminum alloy. In alternate embodiments other suitable photoconductive surfaces and conductive substrates may also be employed. Belt 11 moves in the direction of arrow 12 to advance successive portions of the photoconductive surface through the various processing stations disposed about the path of movement thereof. Belt 11 is generally supported by three rollers 14, 16 and 18 located with parallel axes at approximately the apexes of a triangle. Roller 14 can be rotatably driven by a suitable motor associated with a drive (not shown) to move belt 11 in the direction of arrow 12. In alternate embodiments, any suitable type, of rollers and drive motors can be used.

Initially, a portion of belt 11 passes through charging station A. At charging station A, a corona generating device, indicated generally by the reference numeral 20, charges the photoconductive surface of belt 11 to a relatively high, substantially uniform potential.

Next, the charged portion of the photoconductive surface is advanced through imaging station B. At imaging station B, an imaging unit 22 records an electrostatic latent image on the photoconductive surface of belt 11. Imaging unit 22 can include a raster output scanner. The raster output scanner lays out the electrostatic latent image in a series of horizontal scan lines with each line having a specified number of pixels per inch. Preferably, the raster output scanner employs a laser which generates a beam of light rays that are modulated by rotating polygon mirror blocks or solid state image modulator bars. Alternatively, the raster output scanner may use light emitting diode array write bars. In this way, the first electrostatic latent image is recorded on the photoconductive surface of belt 11.

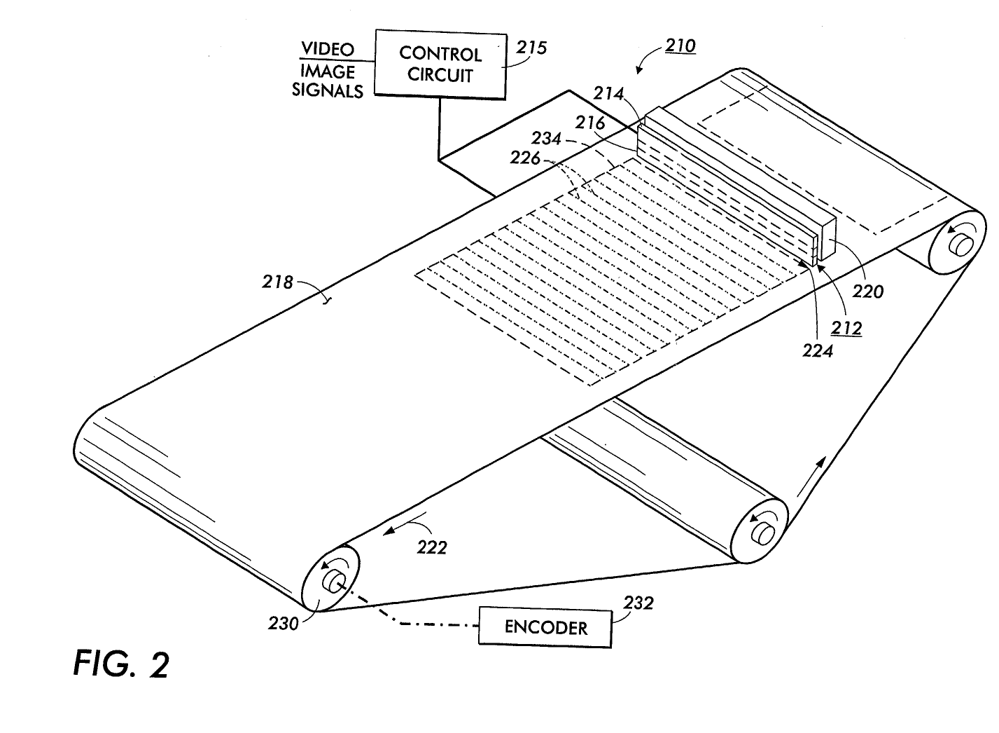

FIG. 2 illustrates a printing system incorporating a raster output scanner (ROS) 210 as one type of high bandwidth line writing device that may be used with the disclosed embodiments. As exposure station 212, (shown as LED array bar imager 30 in FIG. 1) is shown including a light emitting diode (LED) print bar 214. Print bar 214 is selectively addressed by video image signals processed through control circuit 215 to produce a modulated output which is coupled through a respective gradient index lens array 216 onto the surface of charged photoreceptor belt 218 (shown as belt 11 in FIG. 1). Charging device 220 (Shown as changing device 28 in FIG. 1) resides upstream of exposure station 212 to place a predetermined electrical charge on the surface of belt 218. As drive roll 230 rotates to transport belt 218, image area 234 moves past the print bar 214 which provides an exposure pattern in response to the video data input. The exposure pattern is formed of a plurality of closely spaced transverse scan lines 226 shown with exaggerated longitudinal spacing on image area 234. Down-stream from exposure station 212 is a development system (not shown) (shown as station 26 in FIG. 1) that develops a latent image of the exposure. The fully developed image is then transferred to a blank copy sheet.

The images formed by the laser ROS imager generally have some bow or distortion along the process direction as shown in FIG. 5A. For a single imager this is not a problem since all scan lines have the same distortion and it is usually too small to notice. In the color highlight printer system shown in FIG. 1, the LED bar does not normally generate images with bow as shown in the scan lines 402 of FIG. 5B. However, when the black and highlight images are superimposed, on belt 11 the distortion of the ROS will become apparent as shown by image 403 of FIG. 5C. FIG. 5C illustrates the effect of superimposing both ROS and LED scans. The disclosed embodiments recognize that it is not necessary to remove or eliminate the ROS bow, but rather, the behavior of at least one of the two images can be adjusted in order to match the distortion.

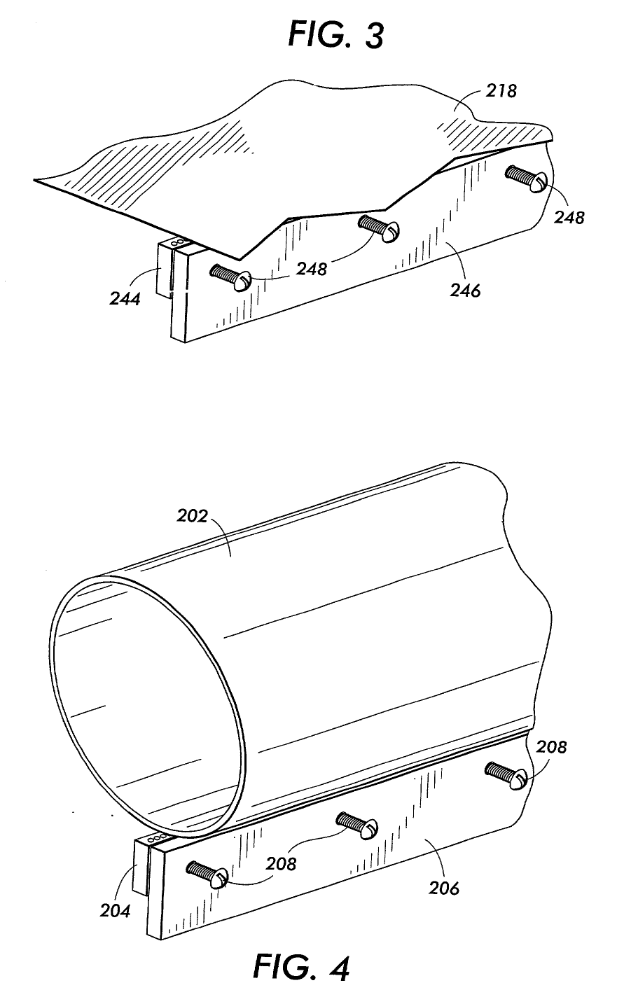

FIG. 3 illustrates an exploded view of a bow scan line adjustment mechanism or compensation device in a system comprising an LED imager 244 and a photoreceptor belt 218. As shown in FIG. 3, the registration plate 246 of the LED bar 244 can be mechanically warped until it mimics the bow behavior of the ROS. As shown in FIG. 3, in one embodiment, the registration plate 246 of the LED bar 244 can include warping screws 248. Although screws are shown in FIG. 3, any suitable adjusting mechanism or device can be used. If one end of the LED bar 244 is fixed, then a screw at the other end can be adjusted to remove any skew differences between the LED bar 244 and laser ROS. At least one additional screw in the center of the bar is needed to introduce bow. Additional screws can be placed along the bar to provide finer control of the mechanical warping. By adjusting warping screws 248, the LED bar 244 is mechanically distorted until the behavior of the two images match. Although a mechanical adjustment system is shown in FIGS. 3 and 4, in an alternate embodiment, an automatic or semi-automatic adjustment system can be used.

FIG. 4 illustrates another embodiment of a mechanical bow scan line adjustment system or compensation device incorporating features of the disclosed embodiments where the photoreceptor belt is replaced with a photoreceptor drum 202. The process is similar to that described with reference to FIG. 3 where warping screws 208 are adjusted to warp the LED bow 204 until it mimics the bow behavior of the ROS.

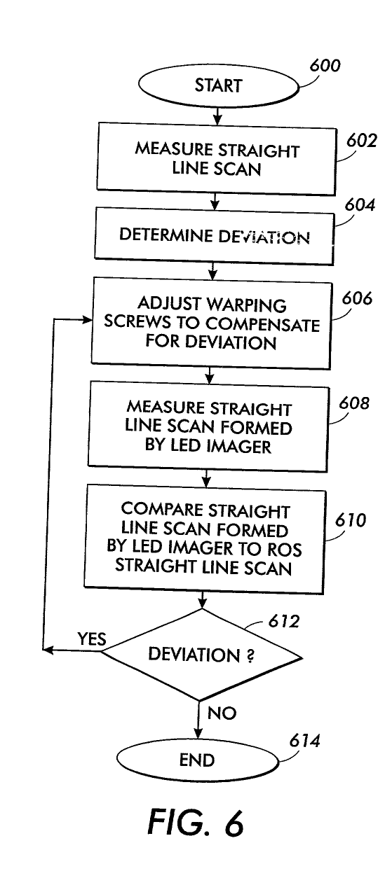

FIG. 6, illustrates a flowchart for one method of adjusting an image produced by LED bar imager to match the bow present in a ROS image is illustrated. For example, in one embodiment, a straight line scan formed by the ROS is measured 602. The deviation of the straight line scan from the desired positions along its length are determined 604. Referring to FIG. 3, the screws 248 in the registration plate 246 are adjusted 606 to compensate for the deviation. A straight line scan formed by the LED imager is measured 608 and compared 610 to the ROS straight line scan. Further adjustments 606 can be made to each warping screw 248 to cause the registration plate 246 to form to the deviation. An alternative approach to adjusting the distortion is to print a pattern of black scan lines using the ROS (e.g. alternating on and off lines, or alternating two lines on and two lines off). The same pattern of highlight scan lines is also printed using the LED imager. One would then examine the resulting print for moiré patterns. The number of moiré bands will indicate the amount of bow that is needed. Screws 248 can be adjusted until the moiré disappears.

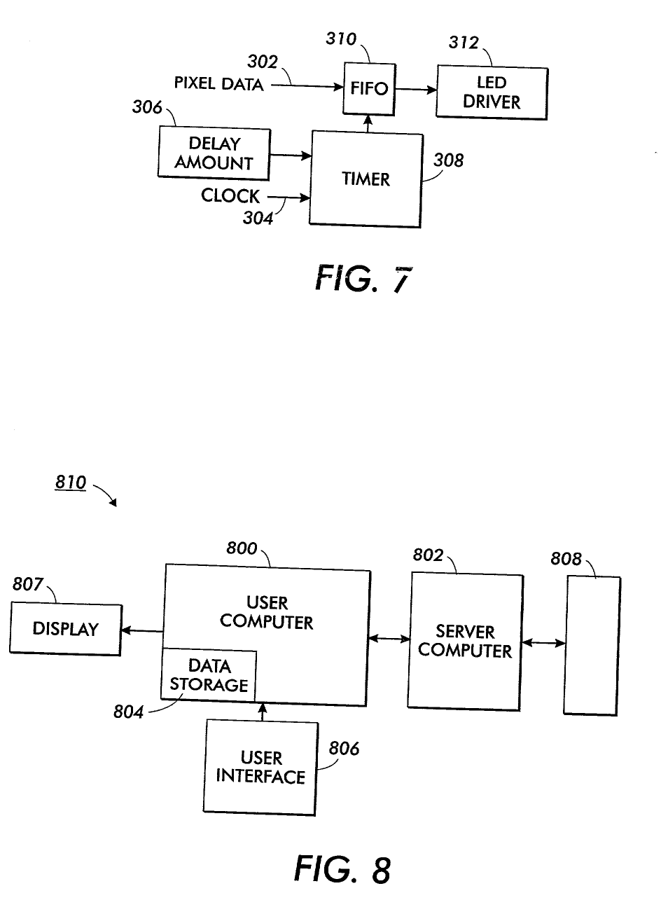

In one embodiment, referring to FIG. 7, the disclosed embodiments can include a bow scan line adjustment mechanism or compensation device that is adapted to electronically distort the image data in order to match or mimic the bow behavior of the ROS. FIG. 7 illustrates a control circuit adapted to vary the timing for illuminating the various pixels along the LED imager 30 shown in FIG. 1, in order to match the bow of the ROS. To match ROS image bow, the pixel illumination in the LED imager can be advanced or delayed. This can result in a shift of the pixel position along the process direction. Generally, the image data in the LED bar can be delayed to match the bow of the ROS. To determine the ROS bow, in one embodiment, an apparent straight line scan line formed by the ROS can be printed and then measured to determine any deviation from the desired position at points along its length. The position deviation information can be adapted to correspond to each LED position in the LED bar. One embodiment of a method of electronically distorting the image data in the LED bar could comprise the steps referred to in FIG. 6, except that step 606 shown in FIG. 6 is replaced by the step of advancing/delaying pixel illumination in the LED bar to match the ROS image bow. It is also possible to measure a few points along the scan line and interpolate to fill in the rest. The method of printing patterns using both ROS and LED bar and then measuring moiré patterns can also be employed. The distance measurements, or deviations, can be converted into time values by dividing by the speed that the paper moves past the LED bar. The times can be measured in terms of the clock cycles for the system.

Referring FIG. 7, in one embodiment to determine an appropriate delay for the pixel illumination of each LED in an LED array, in one embodiment, a memory 306 can be used to store the measured or interpolated delay amount in clock cycles. For example, in one embodiment, the system electronics would accept the incoming scan lines, determine any bow, and send pixel imaging commands to each LED element at the appropriate time to match the ROS bow. A FIFO device 310 for each LED could be adapted to hold enough pixel data 302 for the maximum amount of delay desired from that LED position. A timer 308 can be used to determine an appropriate time at which the imaging signal should be forwarded to the LED driver 312. The clock cycles 304 can be inputted to the timer 308. The timer 308 begins counting clock cycles when the pixel data 302 starts arriving at the FIFO 310. Data 302 collects in the FIFO 310 until the timer 308 counts as many clock cycles as indicated by the delay amount. Thereafter, the timer 308 signals output of the data from the FIFO 310 to the LED driver 312 with each incoming data value.

The features of the disclosed embodiments may also include software and computer programs incorporating the process steps and instructions described above that are executed in different computers. FIG. 8 is a block diagram of one embodiment of a typical apparatus 810 incorporating features of the disclosed embodiments that may be used to practice the present invention. As shown, a computer system 800 may be linked to another computer system 802, such that the computers 800 and 802 are capable of sending information to each other and receiving information from each other. In one embodiment, computer system 802 could include a server computer adapted to communicate with a network, such as for example, the Internet. Computer systems 800 and 802 can be linked together in any conventional manner including a modem, hard wire connection, or fiber optic link. Generally, information can be made available to both computer systems 800 and 802 using a communication protocol typically sent over a communication channel 808 such as the Internet, or through a dial-up connection on ISDN line. Computers 800 and 802 are generally adapted to utilize program storage devices embodying machine readable program source code which is adapted to cause the computers 800 and 802 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 800 and 802 may also include a microprocessor for executing stored programs. Computer 800 may include a data storage device 804 on its program storage device for the storage of information and data. The computer program or software incorporating the processes and method steps incorporating features of the present invention may be stored in one or more computers 800 and 802 on an otherwise conventional program storage device. In one embodiment, computers 800 and 802 may include a user interface 806, and a display interface 807 from which features of the disclosed embodiments can be accessed. The user interface 806 and the display interface 807 can be adapted to allow the input of queries and commands to the system, as well as present the results of the commands and queries. The apparatus 810 shown in FIG. 8 can be integrated into the system 10 shownin FIG. 1, or be provided as a separate, stand-alone unit coupled to the system 10.

In one embodiment, the electronic warping approach allows the same hardware to be used to support high addressability in the process direction. The positioning of the imaging illumination is controlled to a much finer degree is this direction than the separation between illuminators. A delay amount corresponding to the addressability shift of each pixel value is combined with a delay amount corresponding to the warping to match the ROS bow.

The features of the disclosed embodiments spatially matches the aerial image of an LED image bar to the aerial image of an ROS imager. The features of the disclosed embodiments cause the LED image line to have the same amount of bow as the ROS image line, thus ensuring high quality image registration.

It should be understood that the foregoing description is only illustrative of the invention. Various alteratives and modifications can be devised by those skilled in the art without departing from the invention. Accordingly, the present invention is intended to embrace all such alternatives, modifications and variances which fall within the scope of the appended claims.

What is claimed is:

1. A multiple image station printer system comprising:
a first imaging station comprised of a laser raster output scanner imager; and
a second imaging station, wherein the second station is adapted to be adjusted in order to output an image that matches an image bow that is present in an image produced by the first imaging station.

2. The system of claim 1 wherein the second imaging station comprises an LED array bar imager.

3. The system of claim 1 wherein the second imaging station further includes a registration plate, the registration plate being adapted to be mechanically warped so that the image produced by the second imaging station matches the image bow of the image produced by the raster output scanner imager.

4. The system of claim 1 further comprising a LED pixel illumination timing control system, wherein the timing control system is adapted to determine the image bow produced by the raster output scanner imager and control pixel illumination in the second imaging station in order match the image bow in the image produced by raster output scanner imager.

5. The system of claim 4 wherein the timing control system is adapted to delay an illumination of each LED in the second imaging station in order to match the image bow in the image produced by the raster output scanner imager.

6. A method of compensating for image distortion in a print system including a raster output scanner imager and a LED array bar imager, the method comprising the steps of:
determining an image bow of a scanline produced by the raster output scanner imager; and
adjusting a bow scan line compensation device in the LED array bar imager in order to match the image bow of the raster output scanner imager.

7. The method of claim 6 wherein the step of adjusting further comprises the step of mechanically adjusting an adjustment mechanism in the compensation device in the LED array bar imager until a bow of a scan line produced by the LED array bar imager matches the bow of the scan line produced by the raster output scanner imager.

8. The method of claim 6 wherein the step of adjusting a compensation device further comprises the steps of:
adjusting at least one warping screw in a registration plate of the LED array bar imager in order to mechanically distort a scan line produced by the LED bow imager in a direction corresponding to the bow of the scan line produced by the raster output scanner imager;
performing a straight line scan with the LED imager;
comparing the straight line scan of the LED imager with the straight line scan of the raster output scanner; and
repeating the step of adjusting until the scan line of the LED imager matches the scan line of the raster output scanner imager.

9. The method of claim 6 wherein the step of adjusting further comprises the step of electronically distorting image data in the LED imager.

10. The method of claim 6 wherein the step of adjusting further comprises the step of adjusting an illumination of each pixel in the LED array bar in order to shift pixel image data in a process direction in order to match the bow of the scan line produced by the raster output scanner imager.

11. A method of shifting pixel position of an LED array bar imager in a highlight color printer to match image distortion in an image by formed a raster output imager the method comprising the steps of:
determining a bow of a first straight scan line produced by the raster output imager;
matching the bow of the first straight scan line to a second straight scan line of the LED array bar imager by adjusting a timing for an illumination of each pixel in the LED array bar in order to shift the pixel position in the process direction.

12. The method of claim 11 wherein the step of matching further includes delaying image data in the LED array bar to match the bow of the first straight scan line.

13. A computer program product comprising:
a computer useable medium having computer readable code means embodied therein for causing a computer to compensate for image distortion in a multiple image station printer system including a raster output scanner and a LED array bar imager, the computer readable code means in the computer program product comprising:
computer readable program code means for causing a computer to determine an image bow of a scanline produced by the raster output scanner imager; and
computer readable program code means for causing a computer to adjust a bow scan line compensation device in the LED array bar imager in order to match the image bow of the raster output scanner imager.

14. The computer program product of claim 13 further comprising computer readable program code means for causing a computer to electronically distort image data in the LED imager.

15. The computer program product of claim 13 further comprising computer readable program code means for causing a computer to adjust an illumination of each pixel in the LED array bar in order to shift pixel image data in a process direction in order to match the bow of the scan line produced by the raster output scanner imager.

16. The computer program product of claim 13 further comprising computer readable program code means for causing a computer to matching the bow of a first straight scan line to a second straight scan line of the LED array bar imager by adjusting a timing for an illumination of each pixel in the LED array bar in order to shift the pixel position in the process direction.
